(19) United States
(12) Patent Application Publication
(10) Pub. No.: US 2025/0306176 A1
(43) Pub. Date: Oct. 2, 2025

(54) OPTICAL SENSOR

(71) Applicant: CANON KABUSHIKI KAISHA, Tokyo (JP)

(72) Inventors: KAZUTAKA YAGUCHI, SHIZUOKA (JP); TAKUYA MUKAIBARA, SHIZUOKA (JP)

(21) Appl. No.: 19/088,698

(22) Filed: Mar. 24, 2025

(30) Foreign Application Priority Data
Mar. 26, 2024 (JP) 2024-049223

(51) Int. Cl. G01S 7/481

(52) U.S. Cl. CPC G01S 7/4813

(57) ABSTRACT

An optical sensor includes a light emitting unit configured to emit light toward an irradiated object, a light receiving unit configured to receive light that is emitted from the light emitting unit and then reflected by the irradiated object, and a substrate on which the light emitting unit and the light receiving unit are mounted on the same surface, wherein a light absorbing material that absorbs light is formed on an opposite surface to the surface of the substrate on which the light emitting unit and the light receiving unit are mounted in order to suppress light emitted from the light emitting unit from being reflected by the opposite surface and reaching the light receiving unit.

### BACKGROUND

### Field of the Disclosure

The present disclosure relates to an optical sensor that detects a detection object using a light emitting element and a light receiving element.

### Description of the Related Art

In an optical sensor in which a light emitting unit mounted on a substrate irradiates an irradiated portion with light and a light receiving unit receives light reflected from the irradiated portion, unintended light from the light emitting unit may enter the light receiving unit via the substrate (hereinbelow referred to as stray light). If stray light enters the light receiving unit, detection accuracy may deteriorate. Thus, as a measure to prevent stray light from entering a light receiving unit, Japanese Patent Application Laid-Open No. 11-354832 uses a black resist, Japanese Patent Application Laid-Open No. 2006-267644 uses a light shielding coating material (silk), and Japanese Patent Application Laid-Open No. 2019-197072 uses a pattern to cover a surface of a substrate to prevent stray light from entering the substrate.

However, in the methods discussed in Japanese Patent Applications Laid-Open No. 11-354832 and No. 2006-267644, gaps are formed between the light emitting units and the black resist or the light shielding coating material (hereinbelow, the black resist and the light shielding coating material are collectively referred to as light shielding members). This is because it is necessary to separate the light shielding member from the light emitting unit in order to ensure mountability in manufacturing (preventing a mounting portion from overlapping due to manufacturing tolerances). There is a possibility that light will pass through the gap, resulting in an insufficient stray light countermeasure, which is an issue. According to Japanese Patent Application Laid-Open No. 2019-197072, there is concern about a mounting defect due to enlargement of a mounting area, which allows heat to escape more easily during mounting, which is an issue. Therefore, the present disclosure is directed to the provision of an optical sensor that can suppress stray light while ensuring mountability of components.

### SUMMARY OF THE DISCLOSURE

According to an aspect of the present disclosure, an optical sensor includes a light emitting unit configured to emit light toward an irradiated object, a light receiving unit configured to receive light that is emitted from the light emitting unit and then reflected by the irradiated object, and a substrate on which the light emitting unit and the light receiving unit are mounted on the same surface, wherein a light absorbing material that absorbs light is formed on an opposite surface to the surface of the substrate on which the light emitting unit and the light receiving unit are mounted in order to suppress light emitted from the light emitting unit from being reflected by the opposite surface and reaching the light receiving unit.

Further features of the present disclosure will become apparent from the following description of exemplary embodiments with reference to the attached drawings.

### BRIEF DESCRIPTION OF THE DRAWINGS

FIG. 1 is a schematic drawing of an optical sensor according to an exemplary embodiment.

FIGS. 2A to 2D illustrate a stray light countermeasure of an optical sensor according to a first exemplary embodiment.

FIG. 3 illustrates a first stray light area of light emitted from a light emitting diode (LED) to a substrate surface.

FIGS. 4A and 4B illustrate a second stray light area of light emitted from the LED to the substrate surface.

FIGS. 5A and 5B illustrate a first variation of the stray light countermeasure of the optical sensor according to the first exemplary embodiment.

FIGS. 6A to 6C illustrate a second variation of the stray light countermeasure of the optical sensor according to the first exemplary embodiment.

FIGS. 7A and 7B illustrates a case where an LED mounting position is shifted (in a right direction) in the stray light countermeasure of the optical sensor according to the first exemplary embodiment.

FIGS. 8A and 8B illustrate a third variation of the stray light countermeasure of the optical sensor according to the first exemplary embodiment.

FIGS. 9A to 9E illustrate a stray light countermeasure of an optical sensor according to a second exemplary embodiment.

FIGS. 10A to 10D illustrate a variation of the stray light countermeasure of the optical sensor according to the second exemplary embodiment.

### DESCRIPTION OF THE EMBODIMENTS

Exemplary embodiments of the present disclosure will be described with reference to the attached drawings.

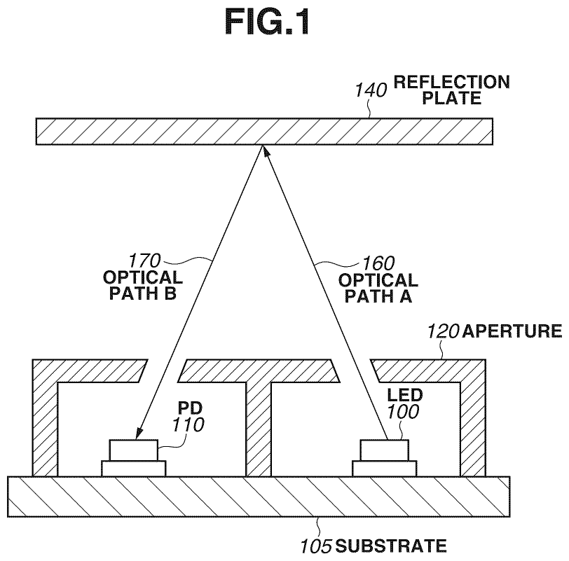

FIG. 1 is a schematic drawing of an optical sensor according to a first exemplary embodiment. FIG. 1 illustrates a light emitting diode (LED) 100, which is a light emitting element, a photo diode (PD) 110, which is a light receiving element that receives light, a paper phenol substrate 105 on which the LED 100 and the PD 110 are mounted on the same surface, an aperture (housing) 120 that narrows light emitted from the LED 100 and received by the PD 110 mounted on the paper phenol substrate 105 at a first hole portion, and a reflection plate (irradiated object) 140 that reflects the light from the LED 100.

The light emitted from the LED 100 is narrowed by a second hole portion of the aperture 120 to form an optical path A 160. The light in the optical path A 160 is reflected by the reflection plate 140, and of the reflected light, the light in an optical path B 170 narrowed by the aperture 120 is received by the PD 110. The reflection plate 140 according to the present exemplary embodiment may be made of any material as long as it reflects light, may be a belt or the like used in an image forming apparatus, and is not limited to the present configuration.

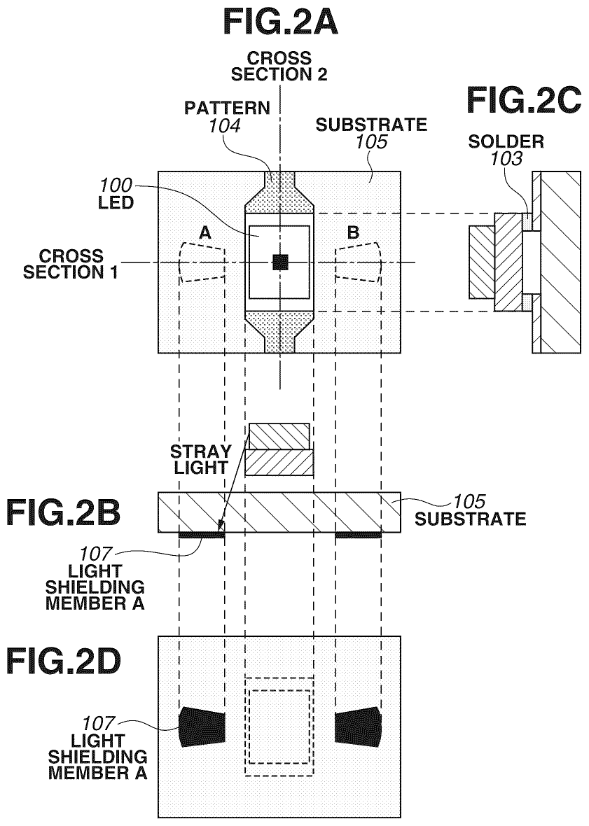

FIGS. 2A to 2D are cross-sectional views of the substrate 105. FIG. 2A illustrates the substrate 105 as viewed from above.

FIGS. 2B and 2C are cross-sections taken along dotted lines of cross sections 1 and 2, respectively.

FIG. 2D is a view from a substrate surface (back surface) opposite to a surface on which the LED 100 is mounted (mounting surface).

FIGS. 2A to 2D indicate a copper foil pattern 104 (hereinbelow, referred to as pattern) with a thickness of 35 um formed on the surface of the substrate 105, a solder 103 that joins an area of the LED 100 and the pattern 104, black silk that is a light shielding member (light absorbing material) A 107 with a thickness of 35 um formed on the back surface of the substrate 105 as a stray light countermeasure according to the present exemplary embodiment. The thicknesses of the pattern 104 and the light shielding member A 107 described above are specific examples of dimensions in substrate manufacturing and are not limited to the present configuration because manufacturing conditions can be changed. The silk color of the light shielding member A 107 may be any color as long as it has low reflectivity (absorbs light) of an emission wavelength of the LED 100 and is not limited to the present configuration.

Light emitted from the LED 100 to the substrate surface passes through the substrate and reaches the back surface. The light draws radiation from a light emitting element inside the LED 100. In FIG. 2A, areas A and B surrounded by dashed lines indicate ranges where the light shielding members A 107 are formed on the back surface from the mounting surface. The portion where the light shielding member A 107 is formed is dominant as an influence of stray light. According to the present exemplary embodiment, the light shielding member A 107 absorbs the light emitted from the LED 100 to the substrate, thereby preventing the light from entering the PD 110 (stray light). The light shielding member A 107 is formed at least between the light emitting unit and the light receiving unit and in a radial range formed by straight lines connecting at least an outer shape of the light emitting unit and an outer shape of the light receiving unit. According to the present exemplary embodiment, one light shielding member A 107 is formed on each of right and left sides.

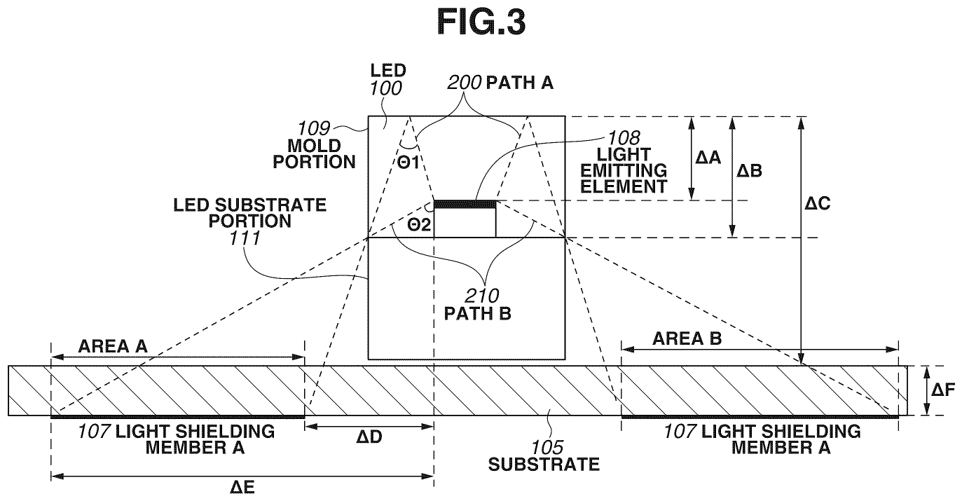

FIG. 3 illustrates paths of light emitted from the LED 100 to the substrate surface in FIG. 2B. In a path A 200 in FIG. 3, light emitted from a light emitting element (light emitting portion) 108 inside the LED 100 is reflected once by a mold portion 109, is radiated on the substrate surface, and reaches the back surface of the substrate 105. Specular reflection is assumed as an example. In a path B 210, light emitted from the light emitting element 108 passes through the mold portion 109 and is radiated on the substrate surface. The light passing through these two paths is a main cause of stray light via the substrate and is a portion where stray light is suppressed (where the light shielding member A 107 is formed) according to the present exemplary embodiment. The light shielding member A 107 is arranged on the back surface, which is different from the mounting surface, and thus does not affect mountability. According to the present exemplary embodiment, it is assumed that an LED substrate portion 111 does not transmit light. In other words, the light radiated on the substrate surface via the path A 200 is limited in a range that is not shielded by the LED substrate portion 111 (θ1 or greater in FIG. 3). Similarly, the light radiated on the substrate surface via the path B 210 is limited in a range that is not shielded by the LED substrate portion 111 (θ2 or greater in FIG. 3).

As an example, a method for calculating the area A where the influence of stray light is dominant is described. It is assumed that a distance from the light emitting element 108 of the LED 100 to a top surface of the mold portion 109 is ΔΔ=0.4 mm, a distance from an upper side of the LED substrate portion 111 to the top surface of the mold portion 109 is ΔB=0.5 mm, a component height of the LED 100 is ΔC=1.1 mm (a thickness of the solder 103 can be sufficiently ignored), and a thickness of the substrate 105 is ΔF=1.0 mm. In the path A 200, an angle between an incident angle and a reflection angle on the mold portion 109 is θ1=35°. In this case, a distance from a left end of the light emitting element 108 to a right end of the area A is ΔD=(ΔC+ΔF)*tan (θ1/2)+ΔA*tan (θ1/2)≈0.788 mm. If an angle between a direction perpendicular to the substrate 105 and light emitted from the left end of the light emitting element 108 is θ2=60°, a distance from the left end of the light emitting element 108 to a left end of the area A is ΔE=(ΔC+ΔF−ΔA)*tan (θ2)≈2.944 mm. As the angle θ2 approaches 90°, the distance ΔE increases. However, as the optical path becomes longer, light intensity decreases, so that the influence of stray light decreases as the distance from the LED 100 increases. Thus, taking into account the influence of stray light, the distance ΔE may be set up to twice (≈6.799 mm) the current optical path (=(√((ΔC+ΔF−ΔA)\hat{ }2+(2.944)\hat{ }2)≈3.399 mm, if θ2=60°), and ΔE=(√((ΔC+ΔF−ΔA)\hat{ }2+(6.799)\hat{ }2)≈7.008 mm. The above-described values depend on the structure and optical characteristics of the LED 100 to be used and thus are not limited to the present configuration.

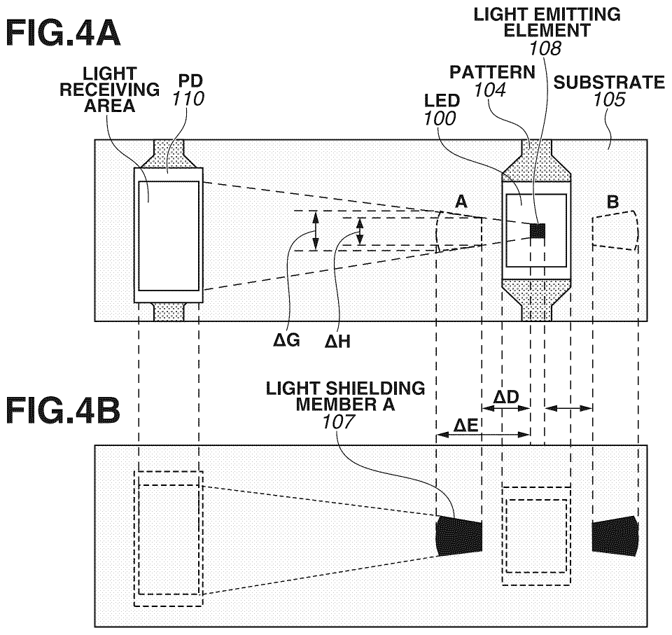

FIG. 4A illustrates ranges of the areas A and B where the light shielding members A 107 on the back surface are formed in FIG. 2A from the mounting surface. FIG. 4A is an example illustrating the ranges of the areas A and B where the influence of stray light is dominant. FIG. 4B illustrates ranges where the light shielding members A 107 are formed from the back surface.

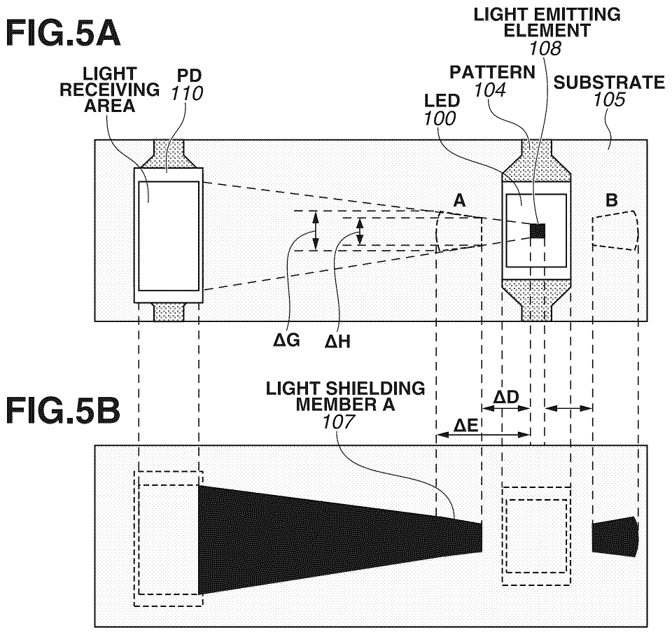

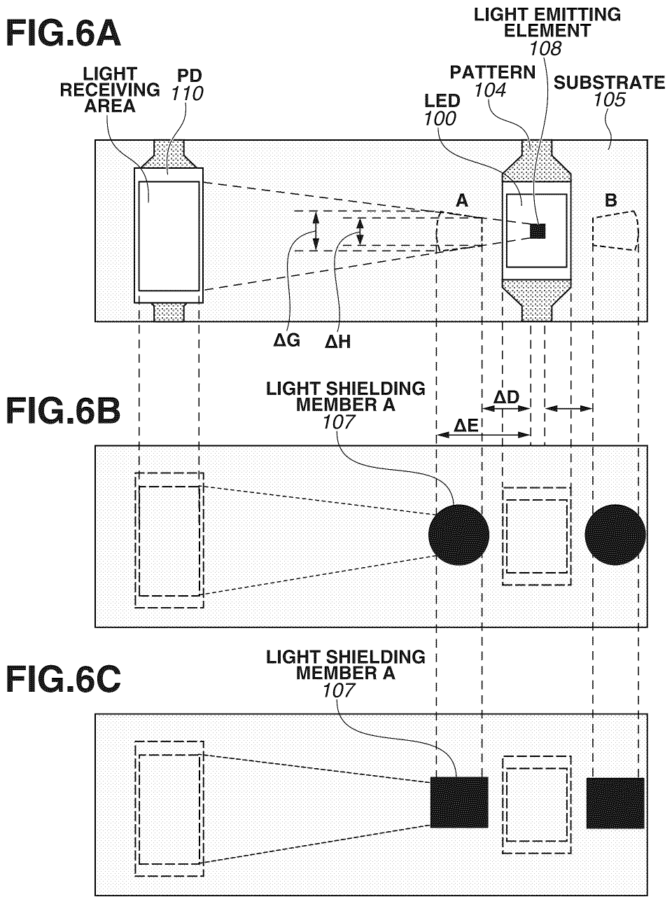

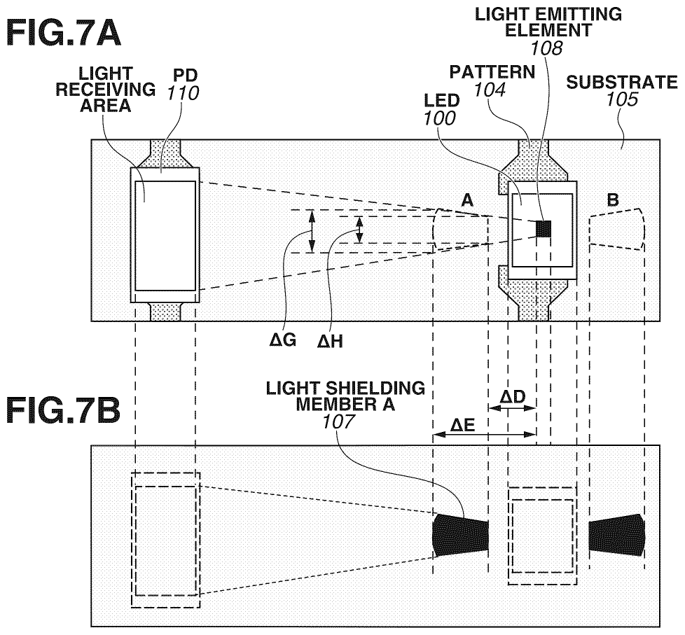

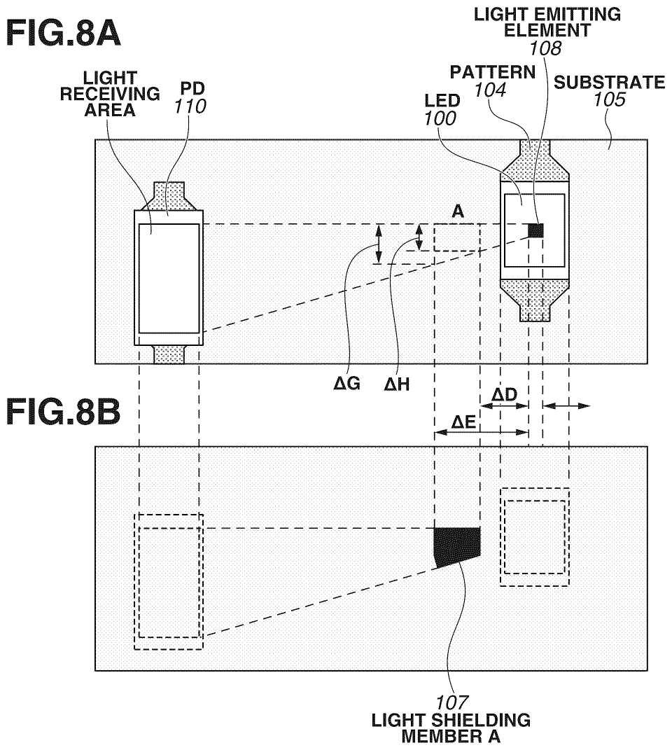

Light emitted from the light emitting element 108 to the substrate surface passes through the substrate 105, enters a light receiving area (light receiving portion) of the PD 110, and thus becomes stray light. Thus, as illustrated in FIGS. 4A and 4B, the area A is a portion surrounded by dotted lines in the drawing connecting an outer shape of the light emitting element 108 and an outer shape of the light receiving area of the PD 110 and a range of the distance ΔD or more and the distance ΔE or less from the left end of the light emitting element 108. As an example, it is assumed that a size of the light emitting element 108 is 0.1 mm*0.1 mm, a longitudinal length of the light receiving area of the PD 110 is 0.7 mm, and a distance from the left end of the light emitting element 108 to a right end of the light receiving area is 5 mm. In a case where the center of the light receiving area and the center of the light emitting element 108 are on a straight line, the distance ΔD=0.788 mm, and the distance ΔE=2.944 mm, distances ΔG and ΔH in the drawing are ΔG≈0.508 mm and ΔH≈0.209 mm, respectively. According to the present exemplary embodiment, the range of the area A is the outer shapes of the light emitting element 108 and the light receiving area of the PD 110. However, in a case where a reflector has a function of diffusing light from the light emitting element 108, an entire outer shape of the LED 100 serves as a light source. Similarly, since there is a component with a light receiving area equivalent to a component outer shape of the PD 110, the range of the area A may be the outer shapes of the LED 100 and the PD 110. In a case where a PD (not illustrated) different from the PD 110 is located on an opposite side across the LED 100, the area B can be calculated in the same manner as the example of the area A. On the other hand, even if there is no different PD, the influence of stray light is less than that in the area A, but the light emitted to the area B is diffusely reflected in the substrate 105, enters the PD 110, and becomes stray light. Thus, it is also necessary to suppress stray light in the area B using the light shielding member A 107 serving as a countermeasure pattern. The distances ΔD and ΔE in the area B are calculated in a similar method, and thus description thereof is omitted here. The distances ΔG and ΔH may be the same as those in the area A or may be determined using other optical conditions. For example, as described above, since the light intensity decreases as the optical path becomes longer, the distances may be determined based on a range where the light intensity sufficiently decreases or a range where the light is shielded by the LED substrate portion 111. Since positions of the areas A and B change depending on a position of the light emitting element 108 within the LED 100, the positions of the areas A and B may not be uniform on the right and left sides with respect to the LED 100. Widths and lengths of the areas A and B may be formed so that at least the areas A and B described above can be covered by the light shielding member A 107. The widths and lengths of the areas A and B may extend to a range surrounded by two straight lines extending from the light emitting element 108 to both ends of the light receiving area in a direction perpendicular to a virtual line (not illustrated) connecting the light emitting element 108 and the light receiving area (FIG. 5B). The range where the light shielding member A 107 is formed only needs to be larger than the areas A and B, and thus the shape thereof is not limited to the present configuration. As illustrated in FIGS. 6B and 6C (FIG. 6A is the same as FIG. 4A), the shape may be, for example, circular or rectangular. FIGS. 7A and 7B illustrate the ranges of the areas A and B in a case where it is taken into consideration that a component mounting position of the LED 100 is shifted in the right direction. As illustrated in FIGS. 7A and 7B, the areas A and B need to be enlarged in the right direction compared with FIGS. 4A and 4B in which there is no mounting misalignment. Thus, the widths and lengths of the areas A and B may be determined by taking a variation in a component mounting position into consideration. For example, if the variation in mounting position is ±0.2 mm, a pattern that is at least 0.2 mm larger than the areas A and B may be formed. Since the area to be shielded from light changes depending on the arrangement of the light emitting element 108, as illustrated in FIGS. 8A and 8B, the shape of the light shielding member A 107 also needs to be changed accordingly.

As described above, the light shielding member A 107 is formed on the back surface, so that it is possible to suppress stray light via the substrate near the LED 100 while satisfying mountability.

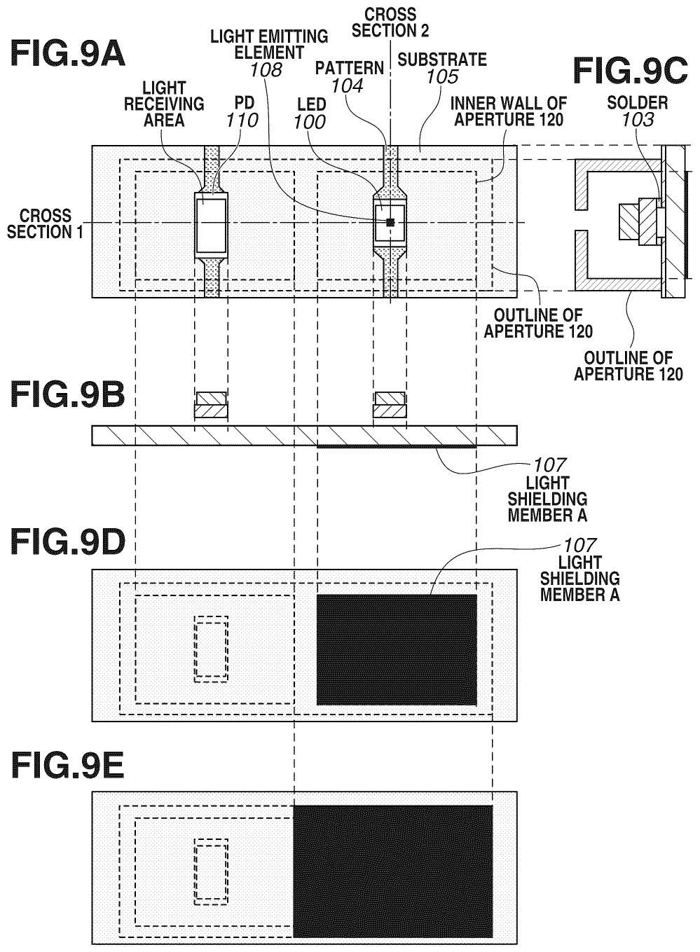

A configuration of a second exemplary embodiment is the same as that according to the first exemplary embodiment, and as illustrated in FIGS. 9A to 9E, the range of the light shielding member A 107 is extended to an inner wall of the aperture 120, so that it is possible to suppress stray light caused by light reflected by the aperture 120. FIGS. 9B and 9C are cross-sections taken along dotted lines of cross sections 1 and 2, respectively. FIG. 9D is a view from the substrate surface (back surface) different from the mounting surface of the LED 100. Parts similar to those according to the first exemplary embodiment are denoted by the same reference numerals, and the descriptions thereof are omitted. FIG. 9A is a view from the mounting surface of the LED 100. A position where the aperture 120 is in contact with the substrate surface (outside the inner wall and inside an outer shape of the aperture 120) is indicated by a dashed line. FIG. 9D illustrates the light shielding member A 107 that is arranged inside the inner wall on the back surface of the substrate 105.

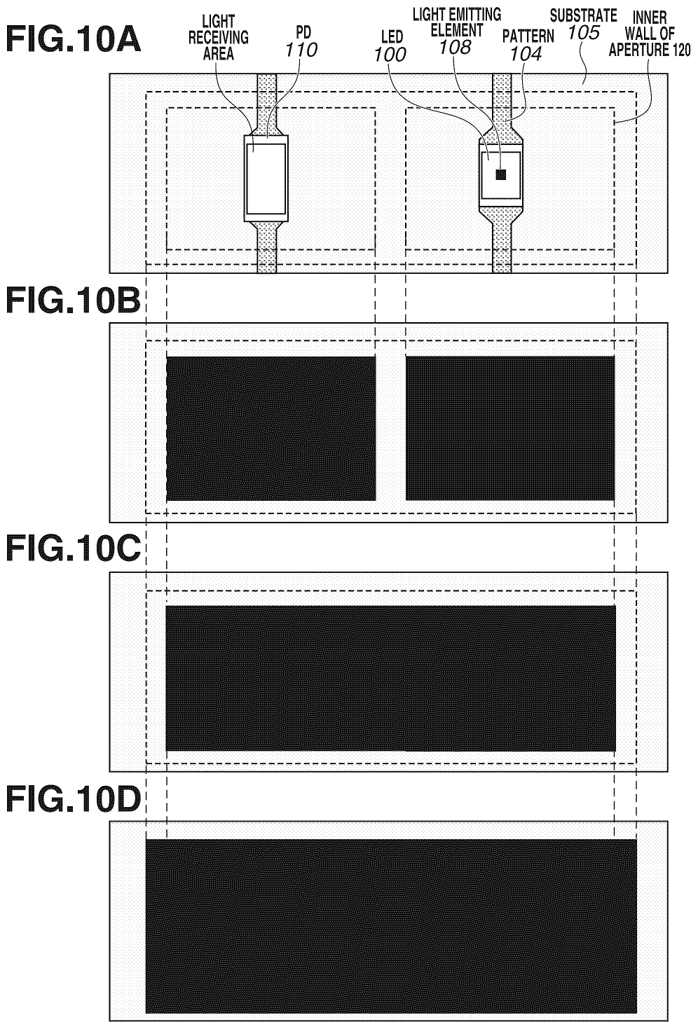

It is useful to select a material with low reflectivity for the aperture 120. However, it is difficult to completely eliminate reflection in terms of cost and surface property. Thus, light from the LED 100 is reflected by the aperture 120 and becomes stray light. According to the present exemplary embodiment, it is possible to suppress stray light by forming the light shielding member A 107 on the back surface of the substrate 105 at a position corresponding to the inside of the inner wall of the aperture 120. According to the present exemplary embodiment, an entire area within the inner wall of the aperture 120 closer to the LED 100 is the range where the light shielding member A 107 is formed, but as illustrated in FIG. 9E, an entire area within the outer shape of the aperture 120 may be the range where the light shielding member A 107 is formed. As illustrated in FIGS. 10B, 10C, and 10D, which illustrate the back surface of the substrate 105 (FIG. 10A is the same as FIG. 9A), the range where the light shielding member A 107 is formed may be set including the inside of the inner wall and the outer shape of the aperture 120 on the PD 110 side.

As described above, the range of the light shielding member A 107 is extended to the inner wall of the aperture 120, so that it is possible to suppress stray light caused by light reflected by the aperture 120.

The above-described exemplary embodiments disclose at least the following optical sensor.

An optical sensor that includes:
a light emitting unit configured to emit light toward an irradiated object;
a light receiving unit configured to receive light that is emitted from the light emitting unit and then reflected by the irradiated object; and
a substrate on which the light emitting unit and the light receiving unit are mounted on the same surface,
wherein a light absorbing material that absorbs light is formed on an opposite surface to the surface of the substrate on which the light emitting unit and the light receiving unit are mounted in order to suppress light emitted from the light emitting unit from being reflected by the opposite surface and reaching the light receiving unit.

The optical sensor according to the item 1,
wherein the light emitting unit includes a light emitting portion and a mold portion,
wherein the light receiving unit includes a light receiving portion, and
wherein the light absorbing material formed on the opposite surface is formed in
a range where light emitted from the light emitting portion reaches the substrate without being reflected by the mold portion,
a range where the light is reflected once by the mold portion and reaches the substrate, and
if viewed in a direction perpendicular to the substrate, a range that is surrounded by two straight lines extending from the light emitting portion to both ends of the light receiving portion in a direction perpendicular to a virtual line connecting the light emitting portion and the light receiving portion.

The optical sensor according to the items 1 and 2,
wherein a housing that includes a first hole portion that surrounds each of the light emitting unit and the light receiving unit and through which the light emitted from the light emitting unit passes and a second hole portion through which the light reflected by the irradiated object passes is installed on the surface of the substrate on which the light emitting unit is mounted,
wherein the light absorbing material that absorbs light is formed on the opposite surface to the surface of the substrate on which the light emitting unit and the light receiving unit are mounted, and
wherein the light absorbing material is formed on an entire area where the housing surrounds the light emitting unit.

The optical sensor according to the item 3,
wherein the light absorbing material that absorbs light is formed on the opposite surface to the surface of the substrate on which the light emitting unit and the light receiving unit are mounted, and
wherein the light absorbing material is formed on an entire area where the housing surrounds the light receiving unit.

The optical sensor according to the items 1 to 4,
wherein the substrate is a paper phenol substrate.

The optical sensor according to the items 1 to 5,
wherein the light absorbing material is silk.

As described above, according to the present disclosure, it is possible to realize an optical sensor that suppresses stray light without being affected by presence or absence of a light shielding member and unevenness of its formation while satisfying mountability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-049223, filed Mar. 26, 2024, which is hereby incorporated by reference herein in its entirety.

What is claimed is:

1. An optical sensor comprising:
a light emitting unit configured to emit light toward an irradiated object;
a light receiving unit configured to receive light that is emitted from the light emitting unit and then reflected by the irradiated object; and
a substrate on which the light emitting unit and the light receiving unit are mounted on the same surface,
wherein a light absorbing material that absorbs light is formed on an opposite surface to the surface of the substrate on which the light emitting unit and the light receiving unit are mounted in order to suppress light emitted from the light emitting unit from being reflected by the opposite surface and reaching the light receiving unit.

2. The optical sensor according to claim 1,
wherein the light emitting unit includes a light emitting portion and a mold portion,
wherein the light receiving unit includes a light receiving portion, and
wherein the light absorbing material formed on the opposite surface is formed in
a range where light emitted from the light emitting portion reaches the substrate without being reflected by the mold portion,
a range where the light is reflected once by the mold portion and reaches the substrate, and
if viewed in a direction perpendicular to the substrate, a range that is surrounded by two straight lines extending from the light emitting portion to both ends of the light receiving portion in a direction perpendicular to a virtual line connecting the light emitting portion and the light receiving portion.

3. The optical sensor according to claim 2,
wherein a housing that includes a first hole portion that surrounds each of the light emitting unit and the light receiving unit and through which the light emitted from the light emitting unit passes and a second hole portion through which the light reflected by the irradiated object passes is installed on the surface of the substrate on which the light emitting unit is mounted,
wherein the light absorbing material that absorbs light is formed on the opposite surface to the surface of the substrate on which the light emitting unit and the light receiving unit are mounted, and
wherein the light absorbing material is formed on an entire area where the housing surrounds the light emitting unit.

4. The optical sensor according to claim 3,
wherein the light absorbing material that absorbs light is formed on the opposite surface to the surface of the substrate on which the light emitting unit and the light receiving unit are mounted, and
wherein the light absorbing material is formed on an entire area where the housing surrounds the light receiving unit.

5. The optical sensor according to claim 1, wherein the substrate is a paper phenol substrate.

6. The optical sensor according to claim 1, wherein the light absorbing material is silk.
